(19) United States
(12) Patent Application Publication
(10) Pub. No.: US 2025/0021873 A1
(43) Pub. Date: Jan. 16, 2025

(54) FIRST NODE, SECOND NODE AND METHODS PERFORMED THEREBY FOR HANDLING DATA AUGMENTATION

(71) Applicant: Telefonaktiebolaget LM Ericsson (publ), Stockholm (SE)

(72) Inventors: Sumit SOMAN, Noida Uttar Pradesh (IN); Sunil Kumar VUPPALA, Bangalore (IN)

(73) Assignee: Telefonaktiebolaget LM Ericsson (publ), Stockholm (SE)

(21) Appl. No.: 18/714,717

(22) PCT Filed: Dec. 2, 2021
(86) PCT No.: PCT/IN2021/051130

§ 371 Date: May 30, 2024

(51) Int. Cl. G06N 20/00

(52) U.S. Cl. CPC G06N 20/00

(57) ABSTRACT

A method performed by a first node (111) for handling data augmentation. The first node (111) divides (201) each epoch in an original dataset having an input space, into a set of batches. The first node (111) generates (202) a set of subsets of samples by selecting, within each batch from every set of batches, a respective plurality of subsets. The first node (111) determines (203), using machine learning, a fourth set of clusters of data using the third set. The first node (111) selects (204) a fifth set of clusters from the fourth set based on a relevance criterion. The first node (111) generates (205) samples in each cluster of the fifth set, and refrains from generating samples in clusters of the fourth set excluded from the fifth set. The first node (111) then generates (206) a sixth set of augmented samples in the input space of the original dataset, by using the generated samples and applying a reverse projection approach.

### TECHNICAL FIELD

The present disclosure relates generally to a first node and methods performed thereby for handling data augmentation. The present disclosure also relates generally to a second node, and methods performed thereby, for handling data augmentation. The present disclosure further relates generally to computer programs and computer-readable storage mediums, having stored thereon the computer programs to carry out these methods.

### BACKGROUND

Computer systems in a communications network or system may comprise one or more nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g., a Radio Base Station (RBS), which sometimes may be referred to as e.g., Fifth Generation (5G) Node B (gNB), evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood as the geographical area where radio coverage is provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

User Equipments (UEs) within the communications network may be e.g., wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

In 3rd Generation Partnership Project (3GPP) Long Term Evolution (LTE), base stations, which may be referred to as gNBs. eNodeBs or even eNBs, may be directly connected to one or more core networks.

Nodes in a core network may use machine learning (ML) techniques to analyze data in the communications network.

The performance of a machine learning model may be understood to depend on the data available to train the model. If ample training data is available, the model may be trained to learn the data distribution well, and consequently, it may be expected to perform well on the test data samples when it may be used for obtaining predictions. On the other hand, when training data is inadequate, or low training data is available due to various constraints, the model training may be understood to be sub-optimal, and as a result, its performance, or generalization ability, may be poor, which is undesirable. In such cases, methods may be employed to generate additional training data samples, which may be also known as data augmentation. These methods may be employed in cases when either less training data is available overall, or training data of a specific class of interest is low, e.g., unbalanced datasets.

Data augmentation approaches may also serve use-cases other than improving model generalization. When low training data is available, the user may employ an augmentation approach for synthesizing new samples representative of the class, e.g., label, distributions in the original dataset. These samples may be used to understand other input space representations or generate diversity in the dataset. “Input space” may be understood to refer to the space spanned by the number of variables, or dimensions, used to originally represent the samples. For example, if data of individuals is collected with name, age and height as variables/attributes/features, the input space may be understood to be the three-dimensional space spanned by name, age, height, as any individual may be represented by a set of these the three values. “Representation” may be used to indicate a specific instance of a sample in the input space. For example, if a set of images of malignant/benign tumors from an image dataset is considered, each image may be a representation in the input space, of 400 dimensions if the images are of size 20×20, as an example. The user may also require a significantly large number of new samples, in which case such methods, that may synthesize new samples based on existing class distributions, may need to be scalable. For such applications, projection spaces generated from a trained model may be leveraged to generate new samples. In the present document, the term “augmentation” is used in the context of generation of synthetic samples for a dataset. “Projection space” may be understood to refer to a space other than the input space in which the samples, also referred as data points, originally existed, that may have been realized by applying a transformation to the samples in the input space. For example, if an image of size 20×20 is cropped to half its size, e.g., 10×10, then the input space of 400 may be transformed to a projection space of 100 by the cropping transformation.

Conventional approaches for data augmentation tend to add samples in the input space of the samples. For high-dimensional data, this approach is undesirable since discriminative representations may lie in a low-dimensional space, which may be referred to elsewhere as the curse of dimensionality. “Discriminative representations” may be understood to refer to projections that may enable to distinctly identify the categories of interest, also known as “classes”. In a discriminative representation, samples of the same class may lie close together. For example, if it may be desired to detect in a set of tumor images which may be malignant or benign, which may be understood to be the two classes, it may be necessary to represent these images in a space where it may be possible to discriminate, that is, distinguish, the malignant images from the benign ones, and this may require some transformation(s) on the original images. A machine-learning model, e.g., a neural network, trained to distinguish these classes may effectively “learn” such a discriminative representation through a series of transformations induced by the neurons in various layers and the weights connecting them. Augmentation in the input space may lead to addition of noise, that is, addition of non-representative samples, which may be a risk for robust model training, e.g., for tasks such as classification. In such cases, it may be useful to project the data to a lower-dimensional, discriminative space, and perform augmentation.

However, when data augmentation is performed in such low dimensional spaces, there may be a need to obtain the augmented data samples back in the input space for further processing. Obtaining augmented samples back in input space may be understood to refer to finding a representation in the original space of variables/features from the projected space for the samples. Though processing may continue in the low dimensional space, this may not be always the desired use-case. This may be understood to be because the task of data augmentation, that is, the generation of new samples, may ideally expect the output represented with the same number of variables as the input.

Obtaining augmented samples back in input space may be understood to be another challenge since the input space may be understood to be over-determined, and as such, there may be no unique solution while performing this “reverse” projection. Existing approaches do not provide for a method to control the parameters of such a reverse projection, which may influence the quality of the augmented data sample. Moreover, the scale of data augmentation provided by a method may be understood to be important, so that the extent to which a given input dataset may be augmented by generating additional samples may be increased as required.

US20200210808A1 [1] uses an autoencoder-based approach to generate the latent space projections and the augmented samples are generated by the trained decoder. An autoencoder may be understood to be an encoder-decoder pair, where the effect of the encoder may be analogous to the forward projection induced by the layers of a neural network, and the decoder may invert this projection. Just the optimal weights of a neural network may be found using a training procedure, this may be needed for both the encoder and decoder networks of an autoencoder. This may be understood to involve the training procedure optimizing a larger number of model parameters, that is, the network weights of the encoder and decoder.

U.S. Ser. No. 10/817,805B2, US20210019658A1 and US20210097348A1 [2,3] focus on approaches that involve augmentation policy selection using multiple parameters for selection of policy, which includes a set of transformations, and magnitude of the transformation to be applied. Further, the approach of [2,3] may be understood to aim to select a data augmentation policy, including sub-policies, for determining an augmented batch of training inputs by transforming the training inputs in the batch of training inputs. WO2021057186A1 [4] details policy selection in an adversarial network setting.

In US20200110994A1 [5], the data augmentation approach involves generating affine transformations of the input dataset. Affine transformations may be understood to involve linear mapping methods that may preserve points, straight lines, and planes in images. For example, rotation, scaling, translation may be understood to be affine transformations. The extent of data augmentation in this approach may be understood to be determined by iteratively estimating the classifier/model loss because of the data augmentation process and then updating the relevant parameter for re-augmentation. Affine transformations may be understood to be possible augmentation methods for image datasets, but these cannot be applied for augmentation of other datasets such as numeric data, text, speech signals etc. In such cases, the task may be understood to be important. For example, with speech data, identifying the speaker may be desired. Thus, augmentation in this setting may be understood to generate new data samples, e.g., speech data, that may closely represent the speaker of interest.

U.S. Ser. No. 10/489,683B1 [6] focuses on generation of augmented samples from 2D representations of 3D model representation of the 3D objects. The method may be understood to be restricted to images and the dimensionality of the projection and input spaces are also specific in this approach.

Existing methods augmenting data may result in augmented data of poor value for its purpose, which may be understood to be to improve the training of machine learning models, to generate models of increased accuracy. Moreover, given the scarcity of data that may be of interest for analysis within the large amount and diversity of data generated in communications networks, existing methods for data augmentation may pose high demands on computational, energy and time resources.

### SUMMARY

As part of the development of embodiments herein, one or more challenges with the existing technology will first be identified and discussed.

The first problem pertains to data augmentation for high dimensional datasets. The relative space occupied by data samples in high dimensions may be understood to be significantly low in reference to the total high-dimensional space. The data may lie in low dimensional manifolds. Hence, augmentation in high dimensional spaces may be understood to be sub-optimal. Thus, conventional approaches such as Synthetic Minority Oversampling (SMOTE), and Adaptive Synthetic sampling approach (ADASYN), and their variants may be understood to not be not suitable as they augment samples in their input space. Moreover, methods have also been devised that primarily handle class imbalance. These may be insufficient for cases where the data collection for all classes may be infeasible or costly to obtain, and as such, the number of samples available for training across all classes of interest may be low. A typical example may be the acquisition of bio signals from sensors for building prosthetic limbs to perform various movements, where the data may be understood to be high dimensional, of the order of the product of sampling rate, number of acquisition channels and time, and difficult to collect across the classes of interest, since conducting large scale human trials may be understood to be cumbersome and infeasible. Existing augmentation methods that work in input space, or augment a specific class, would be inadequate in such cases.

Another set of existing approaches for data augmentation may include affine transformations to images such as rotation, scaling, translation, flipping, among others, which may be often applied to image datasets. However, these methods are applicable only for images where such transformations tend to capture different image representations that the model may be able to learn and perform better. However, they may not be applied to other datasets which may comprise e.g., text, time series, numeric data etc.

Generative Adversarial Networks (GANs) [7] have recently found many applications in generating new data samples, including high-dimensional datasets such as images. Such generative models may involve training competing networks with unstructured data to learn underlying distributions, while generating samples which may also belong to existing or new classes. In principle, GANs may be understood to be not designed to augment data in supervised settings, although variants have been designed such as conditional GAN or Auxiliary Classifier GAN (AC-GANs) [8] that may address class-specific data imbalance. However, stability and mode collapse issues may arise in training GANs and approaches for resolution may be understood to increase computational complexity and time.

The scale at which data augmentation may be performed may also influence model generalization [9], as several applications may require a larger number of augmented samples for better model training, or for addressing other user requirements, for example, users may need to see more samples of a specific class of interest. Conventional approaches may usually provide parameters that may be set to compensate for the class imbalance by suitably oversampling the minority class. These parameters may be used in such approaches to generate new samples, but the scale of augmentation is not influenced by the quality of data representation in the augmentation space.

As mentioned earlier in this section that augmentation for high-dimensional datasets is preferred in representative low dimensional spaces, the need for projecting back the augmented samples to the original input space presents a challenge. Existing approaches such as GANs or variational autoencoders have limitations in providing for the projection back to input space independently since the encoder-decoder network training may be understood to be dependent or constrained respectively.

As a further problem, the extent of augmentation possible by using multiple policies may be understood to be limited by the number of policies that may be identified. Also, not all policies may be applicable for all kinds of data. For example, while flipping as an augmentation policy may be meaningful for an image, flipping a speech signal may not be useful.

According to the foregoing, it is an object of embodiments herein to improve the handling of data augmentation in a communications system.

According to a first aspect of embodiments herein, the object is achieved by a computer-implemented method, performed by a first node. The method is for handling data augmentation. The first node operates in a communications system. The first node divides each epoch, of a first set of training data epochs in an original dataset having an input space, into a second set, N, of batches. The first node then generates a third set, K, of subsets of samples by selecting, within each batch from every second set, N, of batches, a respective plurality of subsets of one or more samples. Each subset is different from another subset. The first node determines, using machine learning, a fourth set of clusters of data using the determined third set, K, of subsets of samples as input. The first node selects a fifth set of clusters from the fourth set of clusters based on a criterion of relevance. The first node generates samples in each cluster of the selected fifth set of clusters, and refrains from generating samples in clusters of the fourth set of clusters being excluded from the fifth set of clusters. The first node generates a sixth set of augmented samples in the input space of the original dataset. The first node generates the sixth set by using the generated samples and applying a reverse projection approach to transform the generated samples into transformed samples of the input space of the original dataset, added to the original dataset.

According to a second aspect of embodiments herein, the object is achieved by a computer-implemented method, performed by the second node. The method is for handling data augmentation. The second node operates in the communications system. The second node receives a further indication from the first node operating in the communications system. The further indication indicates a sixth set of augmented samples generated according to the method described for the first node.

According to a third aspect of embodiments herein, the object is achieved by the first node, for data augmentation. The first node is configured to operate in the communications system. The first node is further configured to divide each epoch, of the first set of training data epochs in the original dataset having the input space, into the second set, N, of batches. The first node is also configured to generate the third set, K, of subsets of samples by selecting, within each batch from every second set, N, of batches, the respective plurality of subsets of the one or more samples. Each subset is configured to be different from another subset. The first node is additionally configured to determine, using machine learning, the fourth set of clusters of data using the determined third set, K, of subsets of samples as input. The first node is further configured to select the fifth set of clusters from the fourth set of clusters based on the criterion of relevance. The first node is also configured to generate samples in each cluster of the selected fifth set of clusters, and refrain from generating samples in clusters of the fourth set of clusters being excluded from the fifth set of clusters. The first node is further configured to generate the sixth set of augmented samples in the input space of the original dataset. The first node is further configured to generate the sixth set by using the generated samples and applying the reverse projection approach to transform the generated samples into transformed samples of the input space of the original dataset, added to the original dataset.

According to a fourth aspect of embodiments herein, the object is achieved by the second node, for handling data augmentation. The second node is configured to operate in the communications system. The second node is further configured to receive the further indication from the first node configured to operate in the communications system. The further indication is configured to indicate the sixth set of augmented samples configured to be generated according to the method described as performed by the first node.

According to a fifth aspect of embodiments herein, the object is achieved by a computer program, comprising instructions which, when executed on at least one processor, cause the at least one processor to carry out the method performed by the first node.

According to a sixth aspect of embodiments herein, the object is achieved by a computer-readable storage medium, having stored thereon the computer program, comprising instructions which, when executed on at least one processor, cause the at least one processor to carry out the method performed by the first node.

According to a seventh aspect of embodiments herein, the object is achieved by a computer program, comprising instructions which, when executed on at least one processor, cause the at least one processor to carry out the method performed by the second node.

According to an eighth aspect of embodiments herein, the object is achieved by a computer-readable storage medium, having stored thereon the computer program, comprising instructions which, when executed on at least one processor, cause the at least one processor to carry out the method performed by the second node.

By generating the third set of subsets of samples by selecting the respective plurality of subsets of samples within each batch, the first node may be enabled to achieve two advantages. Firstly, by generating different subsets of the batches, the first node may capture different distributions of the training data samples. Secondly, the first node may significantly increase the scope of data augmentation as each subset may be individually augmented. This approach of generating subsets may be understood to improve both the data distributions captured, as well as the scale of augmentation possible.

By determining the fourth set of clusters of data using the determined third set of subsets of samples as input, the first node may be enabled identify a number of variables from the input space of the original dataset that may be most relevant for a task at hand, and thereby enable to reduce the input space of the original dataset to a low dimensional space. This may in turn enable augmentation of the samples in the low dimensional space, which may increase the quality and computational efficiency of the data augmentation.

By the first node selecting the fifth set of clusters from the fourth set of clusters based on the criterion of relevance, the first node may be enabled to focus on the task-based projections into lower-dimensional spaces for performing meaningful data augmentation. Data augmentation may thereby be enabled to be performed in a low dimensional space, which may increase the quality and computational efficiency of the data augmentation.

By performing the reverse projection implementations, in combination with the techniques for sampling and the sample addition, the first node may be enabled to effectively scale up the projection-based data augmentation pipeline.

By generating the sixth set of augmented samples with the scalable projection approach, the first node may be enabled to obtain high dimensional representations of augmented samples using low dimensional projections. By applying the reverse projection approach, the data augmentation, may represent the new samples with the same number of variables as the input, so that the augmented dataset may be able to be validated as meaningful to work further with.

The first node, or the second node, may then be enabled to use these samples based on the objectives of the application in which the approach may be employed, which may include re-training the model with the augmented dataset, tune augmentation parameters based on the quality of the augmented samples obtained, or provide the new samples for further processing as a service in the machine learning workflow pipeline of the application.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a schematic diagram depicting aspects of a method in a first node, according to embodiments herein.

FIG. 5 is a schematic diagram depicting detailed aspects of a method in a first node, according to embodiments herein.

FIG. 6 is a schematic diagram depicting aspects of a method in a first node, according to embodiments herein.

FIG. 7 is a schematic diagram depicting aspects of a method in a first node, according to embodiments herein.

FIG. 8 is a schematic diagram depicting aspects of a method in a first node, according to embodiments herein.

FIG. 9 is a schematic block diagram illustrating two non-limiting examples, a) and b), of a first node, according to embodiments herein.

FIG. 10 is a schematic block diagram illustrating two non-limiting examples, a) and b), of a second node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein may be understood to overcome the challenges of the existing methods by providing a method for scalable synthetic data generation through projections.

As a summarized overview, embodiments herein may be understood to provide an approach for scalable synthetic data generation. More particularly, this may be achieved first, through combinatorial sampling of input data batches to generate subsets that may capture diverse representations of training data. Second, through augmentation of the samples in a low dimensional space obtained by passing the subset samples through layers of a trained network. This may be performed using a method that may control the scale of augmentation based on the quality of representation of samples in the projected space. Third, the scalable synthetic data generation may be obtained by obtaining the samples back in input space by a scalable reverse projection approach. The reverse projection approach may be parameterized for controlling the quality of the augmented data samples. The approach may be used for augmentation in supervised settings and may augment the sample space by generation of new samples for the existing classes.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

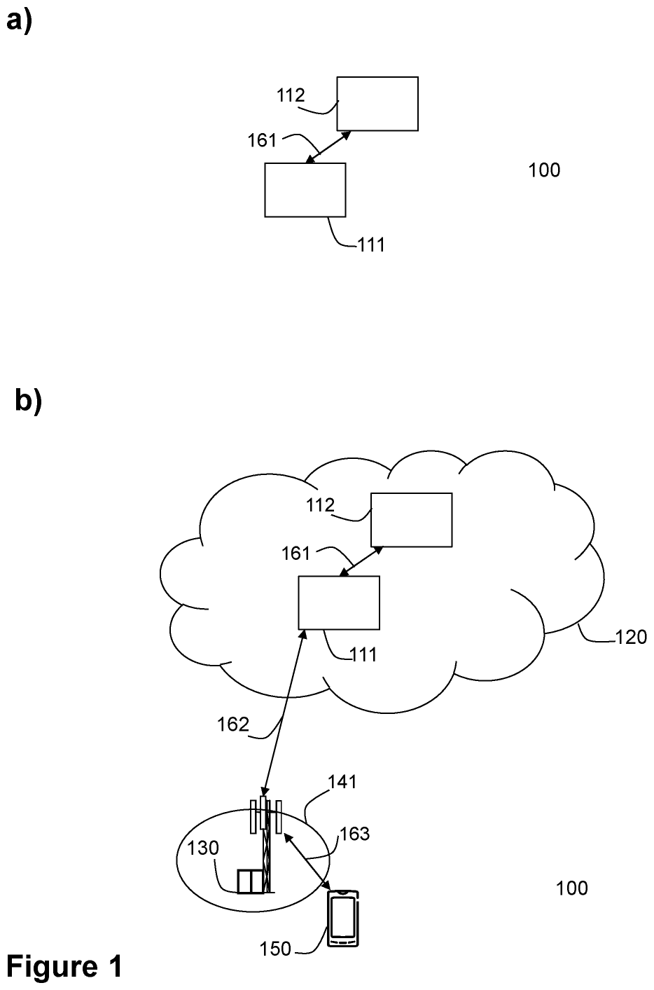

FIG. 1 depicts two non-limiting examples, in panels “a” and “b”, respectively, of a communications system 100, in which embodiments herein may be implemented. In some example implementations, such as that depicted in the non-limiting example of FIG. 1a, the communications system 100 may be a computer network. In other example implementations, such as that depicted in the non-limiting example of FIG. 1b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as a 5G system, e.g., 5G Core Network (CN), 5G New Radio (NR), an Internet of Things (IoT) network, a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The telecommunications system may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 comprises a first node 111, which is depicted in FIG. 1. In some embodiments, the communications system 100 may comprise a plurality of nodes, whereof, a second node 112, is depicted in FIG. 1. It may be understood that the communications system 100 may comprise more nodes than those represented in FIG. 1. Any of the first node 111 and the second node 112 may be understood, respectively, as a first computer system and a second computer system. In some examples, any of the first node 111, and the second node 112 may be implemented as a standalone server in e.g., a host computer in the cloud 120, as depicted in the non-limiting example depicted in panel b) of FIG. 1. Any of the first node 111 and the second node 112 may, in some examples, be a distributed node or distributed server, with some of their respective functions being implemented locally, e.g., by a client manager, and some of its functions implemented in the cloud 120, by e.g., a server manager. Yet in other examples, any of the first node 111 and the second node 112, may also be implemented as processing resources in a server farm.

In some embodiments, the first node 111 and the second node 112 may be independent and separated nodes. In other embodiments, the first node 111 and the second node 112 may co-localized or be the same node. All the possible combinations are not depicted in FIG. 1 to simplify the Figure.

Any of the first node 111 and the second node 112 may be understood as a node having a capability to perform machine-learning.

In some non-limiting examples, the communications system 100 may comprise one or more radio network nodes, whereof a radio network node 130 is depicted in panel b) of FIG. 1. The radio network node 130 may typically be a base station or Transmission Point (TP), or any other network unit capable to serve a wireless device or a machine type node in the communications system 100. The radio network node 130 may be e.g., a 5G gNB, a 4G eNB, or a radio network node in an alternative 5G radio access technology, e.g., fixed or WiFi. The radio network node 130 may be e.g., a Wide Area Base Station, Medium Range Base Station, Local Area Base Station and Home Base Station, based on transmission power and thereby also coverage size. The radio network node 130 may be a stationary relay node or a mobile relay node. The radio network node 130 may support one or several communication technologies, and its name may depend on the technology and terminology used. The radio network node 130 may be directly connected to one or more networks and/or one or more core networks.

The communications system 100 may cover a geographical area, which in some embodiments may be divided into cell areas, wherein each cell area may be served by a radio network node, although, one radio network node may serve one or several cells. In the example of FIG. 1, the network node 130 serves a cell 141. The network node 130 may be of different classes, such as, e.g., macro eNodeB, home eNodeB or pico base station, based on transmission power and thereby also cell size. In some examples, the network node 130 may serve receiving nodes with serving beams. The radio network node may support one or several communication technologies, and its name may depend on the technology and terminology used. Any of the radio network nodes that may be comprised in the communications system 100 may be directly connected to one or more core networks.

The communications system 100 may comprise a plurality of devices whereof a device 150 is depicted in FIG. 1. The device 150 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. The device 150 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 150 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The first node 111 may communicate with the second node 112 over a first link 161, e.g., a radio link or a wired link. The first node 111 may communicate with the radio network node 130 over a second link 152, e.g., a radio link or a wired link. The radio network node 130 may communicate, directly or indirectly, with the device 150 over a third link 153, e.g., a radio link or a wired link. Any of the first link 151, the second link 152 and/or the third link 153 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 1.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

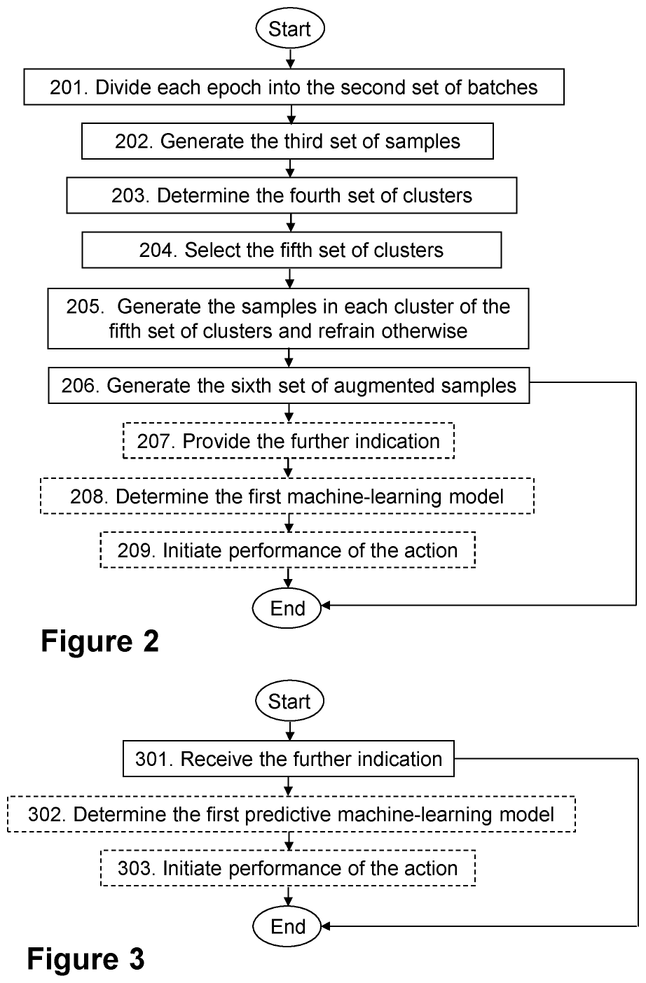

Embodiments of a computer-implemented method, performed by the first node 111, will now be described with reference to the flowchart depicted in FIG. 2. The method may be understood to be for handling data augmentation. The first node 111 operates in the communications system 100.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 2. In FIG. 2, optional actions in some embodiments may be represented with dashed lines.

### Action 201

Embodiments herein may be understood to be used in the context wherein an event, e.g., an event in the communications system 100, may be wished to be analyzed or predicted by, e.g., training a machine learning model. Embodiments herein may be understood to be employed in various use-cases wherein low training data may be available, or when additional samples close to class distribution(s) may be required to be synthesized. These situations may arise in cases where large scale data acquisition may be limited by acquisition factors such as e.g., bio signals for controlling devices, or limited by cost of data acquisition, e.g., rare events, diseases, anomalous events etc.

Training data, that is, data to eventually provide as input to train the machine learning model, may comprise samples. The full set of samples that may be available in the training data to start with may be referred to as an epoch.

In order to ultimately generate synthetic data with a scalable approach, in this Action 201, the first node 111 divides each epoch, of a first set of training data epochs in an original dataset having an input space, into a second set, N, of batches. In other words, within each epoch, the dataset may be divided into batches denoted by B₁, B₂, and so on until BN. This may be performed using a suitable stratified approach for mini batch generation, so that samples of the classes of interest may be well represented in each batch.

A batch may be understood to be a partition of the samples. The batches may be distinct, non-overlapping partitions of the data.

The number of batches to be generated may be a parameter that a user may choose e.g., depending upon the scale of augmentation that may be required for the use case. The upper bound may be determined by the number of samples in the original dataset.

### Action 202

Within each batch, the approach of embodiments herein may involve generation of multiple subsets S of the training data. In this Action 202, the first node 111 generates a third set, K, of subsets of samples. A sample may be understood to refer to a data point.

The first node 111 generates the third set, K, of subsets of samples by selecting, within each batch from every second set, N, of batches, a respective plurality of subsets of one or more samples. Each subset is different from another subset.

The generating in this Action 203 may be performed by using combinatorial sampling.

Combinatorial sampling may be understood to refer to selecting combinations of samples, that is, samples, with replacement, to, in this case, generate subsets. For example, given x samples, subsets may be generated by choosing one to x samples, and each may be done using different combinations of the samples. In this Action 202, the first node 111 may generate subsets from batches by combinatorial selection of samples within each batch in as many ways of choosing k objects from a set of n in the batch. That is, the third set, K, of subsets of samples may be generated by selecting k samples from each batch of n samples for N batches by choosing different values of k, resulting in generation of K subsets. Subsets S may be contained within the respective batches. These subsets may be denoted as S₁, S₂ and so on until S_{K}. S₁, S₂ etc. may be understood to be subsets generated from the batches B₁, B₂ etc

For example, if there are nine samples to start with (x₁, x₂, . . . , x₉), and the batch size is 3, then each of B₁, B₂ and B₃ may have three samples. These may be understood to be distinct, non-overlapping partitions of the data. If batch B₁ has samples {x₁, x₂, x₃}, various subsets may be generated, such as S₁={x₁}, S₂={x₂}, S₃={x₃}, S₄={x₁, x₂}, S₅={x₂, x₃}, S₆={x₃, x₁}, S₇={x₁, x₂, x₃} by choosing one, two or three samples in B1. Therefore, depending on how many samples may be selected, different number of subsets S from a batch B may be generated.

Accordingly, embodiments herein may generate subsets from batches of training epochs using a combinatorial sampling scheme for enabling generation of many augmented data samples.

The number of batches B and number of subsets S to be generated may be understood to be parameters that may be chosen, e.g., by a user, depending upon the scale of augmentation that may be required for the use case. Their upper bounds may be determined by the number of samples, that is, samples, that may be comprised in the original dataset.

According to the foregoing, embodiments herein may be understood to introduce subsampling on batches to create multiple subsets of training data, which may be further processed through the data augmentation pipeline.

By generating the third set, K, of subsets of samples in this Action 202 as described, the first node 111 may then be enabled to achieve two advantages. Firstly, by generating different subsets of the batch, the first node 111 may capture different distributions of the training data samples. Secondly, since these subsets may be generated by combinatorial sampling, the first node 111 may significantly increase the scope of data augmentation as each subset may be individually augmented. This approach of generating subsets by combinatorial sampling may be understood to improve both the data distributions captured, as well as the scale of augmentation possible.

Action 201 and Action 202 may be understood to be comprised in first phase of the method performed by the first node 111, which may be drawn to subset generation by combinatorial sampling of batches, wherein the first node 101 may generate, through combinatorial sampling of input data batches, subsets that may capture diverse representations of training data.

### Action 203

In order to obtain the representation of the determined third set, K, of subsets of samples in a suitable low dimensional projected space, that is, in order to reduce the number of variables in the input space of the original dataset, in this Action 203, the first node 111 determines, using machine learning, a fourth set of clusters of data using the determined third set, K, of subsets of samples as input.

A cluster may be understood as a group of samples, or data points, that may have the same “class”, or category of interest. A machine learning model may be trained to identify discriminative representations of the data points. As such, passing the data points generated by sampling batches earlier, in input space may be transformed to the “projected space” by the ML model.

The determining in this Action 203 of the clusters of data may comprise obtaining the clusters of data by passing the third set, K, of subsets of samples through layers of a trained network, e.g., a neural network, comprised in the first node 111 with the objective of identifying discriminative representations of the original dataset. That is, projections that may enable to distinctly identify, that is, discriminate or distinguish, the categories of interest, also known as “classes”. In a discriminative representation, samples, that is, samples, of the same class may lie close together. This may require some transformation(s) on the original samples. In this Action 203, such a transformation may be performed by passing the samples through the layers of the neural network, where the neurons in each layer may operate upon the “input space” values of the samples, and transform them to the “projected space”. A neural network trained to distinguish these classes may effectively “learn” such a discriminative representation through a series of transformations induced by the neurons in various layers and the weights connecting them. Particularly, the first node 111 may be understood to directly use the intermediate layer representations obtained by passing the sample through trained feed-forward network layers, at a suitable intermediate layer. A set of operations that may transform a sample from the input space to a projected space, often low dimensional compared to the input space, such as by the layers of a neural network, may be understood as a forward projection. For example, a dataset of 400 dimensions (20×20) passed through a neural network having ten neurons in the last layer may result in a ten-dimensional representation for the dataset. This transformation induced by the weights and neurons of such a network may be understood as an example of a forward projection.

By determining the fourth set of clusters of data using the determined third set of subsets of samples as input in this Action 204, the first node 111 may be enabled identify a number of variables from the input space of the original dataset that may be most relevant for a task at hand, and thereby enable to reduce the input space of the original dataset to a low dimensional space. This may in turn enable augmentation of the samples in the low dimensional space, as will be described in the next Actions 204 and 205, which may increase the quality and computational efficiency of the data augmentation, as will be described in the next actions.

### Action 204

In this Action 204, the first node 111 selects a fifth set of clusters from the fourth set of clusters based on a criterion of relevance.

In some embodiments, the criterion of relevance may be a respective indication exceeding a threshold. In some embodiments, the respective indication may be of a ratio of a respective number of samples of a respective class, e.g., a class to be augmented, in each respective cluster of the fourth set of clusters of data, to a respective total number of samples in the respective cluster. In such embodiments, if the ratio is higher than the threshold, e.g., a certain percentage value, the cluster may be selected from the fourth set of clusters, and not otherwise.

By the first node 111 selecting the fifth set of clusters from the fourth set of clusters based on the criterion of relevance in this Action 205, the first node 111 may be enabled to select the most relevant clusters, and thereby focus on the task-based projections into lower-dimensional spaces for performing meaningful data augmentation. The first node 111 may thereby be enabled to perform augmentation of the samples using a method of augmentation based on the quality of representation of samples in the projected space. Data augmentation may thereby be enabled to be performed in a low dimensional space, which may increase the quality and computational efficiency of the data augmentation.

### Action 205

Once the samples of the subsets generated in Action 202 may have been passed through the layers of the network in Action 203 to obtain their representation in a suitable low dimensional projected space, wherein the samples may be clustered in this low dimensional space, augmentation of the samples in the low dimensional space may begin.

In this Action 205, the first node 111 generates samples, that is, data points, in each cluster of the selected fifth set of clusters. In order to ensure that samples may be added only when clusters may be well represented, the first node 111 also refrains from generating samples in clusters of the fourth set of clusters being excluded from the fifth set of clusters.

In order to add samples in each cluster of the selected fifth set of clusters, embodiments herein may comprise the computation of a label ratio metric, which may compute the ratio of the number of samples of a class in a cluster to the total number of samples in the cluster. If the label ratio for a sample is high, e.g., close to 1, the first node 111 may consider that the cluster is well-formed, and may choose to add a larger number of points in this cluster, close to the corresponding sample for which the label ratio may have been computed. On the other hand, if the label ratio is low, e.g., close to 0, it may be desirable to not augment many samples in the cluster, and those that may have to be added, if required, may have to be kept close to the corresponding cluster center.

Thus, by computing the label ratio, the first node 111 may exploit label information to determine the extent of augmentation to be performed within the specific cluster. This may be understood to be an improvement over alternative augmentation approaches that may use metrics to evaluate the clustering output without considering the label information, since an objective of embodiments herein may be understood to be to augment samples for a supervised learning setting.

In some embodiments, the first node 111 may generate the samples in each cluster of the selected fifth set of clusters by using a label-proximity based sample addition scheme for the clustered low dimensional representations of input samples, so that a larger number of samples representative of the classes of interest may be added after evaluating the label-based metric, as required by the use case, e.g., by a user.

Each cluster of the fourth set of clusters may have a respective center. The generating in this Action 206 of samples may be performed in at least one of the following options. According to a first option, the generating in this Action 206 of the samples may be performed within a first distance from the respective center of a respective cluster. According to a second option, the generating in this Action 206 of the samples may be performed within a second distance from a respective sample in a projected space belonging to the respective cluster, that is a sample derived from the original data set, and non-generated in this Action. The projected space may be understood to refer to a low dimensional space of variables to which the samples from the subsets may have been transformed to by the machine learning model, neural network for example. According to a third option, the generating in this Action 206 of the samples may be performed within a certain distance between the respective center of the respective cluster and the respective sample.

The data samples may be clustered in low dimensional space. P new samples [symbol] may be added between each sample x and its cluster center x_{C} as [symbol] =λₚx+(1−λₚ)x_{C} for 0<λₚ<1, λₚ∈ [symbol] and 1≤p≤P, p∈ [symbol] . Sample addition may be done either close to the cluster center or close to the individual sample by adding points on the line joining the sample to the cluster center. More samples may be added by choosing higher P. A label proximity based addition may be also performed by computing a compute label ratio LRₓ=n_{C}^{x}/n_{C}, that is, the ratio of the number of samples of class of sample x in the cluster C (n_{C}^{x}) to the total number of samples in the cluster n_{C}. For high LRₓλₚ→1 may be chosen, to add close to sample, otherwise choose λₚ→0 may be chosen. These approaches may allow to perform label-based or problem based, e.g., class specific imbalance, data augmentation in low-dimensional space. The parameter parameter λ may be considered an additional parameter. The additional parameter may be considered as a scale controlling parameter.

By choosing different values, e.g., between 0 and 1, of the parameter λ, to determine if the sample may be added close to the sample existing in the cluster or the cluster center, the first node 111 may also effectively control the scale of augmentation, which may be understood to also enhance the scale of augmentation provided by embodiments herein, in addition, that is, to the scale provided by the combinatorial subset generation used in the previous phase, described in Action 201 and 202.

While in existing approaches the scale of augmentation is not influenced by the quality of data representation in the augmentation space, embodiments herein may be understood to involve the use of the scale controlling parameters, e.g., parameter λ, in a manner that may be determined by evaluation of the label-based metric in the projection space. depending on how many values of this parameter are chosen, we can add as many new samples As a result, the augmentation approach followed by the first node 111 may enable to add additional samples in spaces that may capture better data representations, by both enabling exploration of such spaces and evaluation of quality metric to influence data augmentation.

According to the foregoing, the augmentation and associated procedure that may be used by the first node 111 may be understood to be parameterized for determining the nature of the augmented samples rather than being based on selection of any augmentation policy. This advantageously enables the first node 111 to make the data augmentation applicable to diverse types of datasets.

Moreover, the first node 111 by in this Action 207 exploiting characteristics of the data samples in the projected space to generate additional samples for augmentation, is enabled to perform data augmentation in a generic manner, as it may perform data augmentation based on the task at hand, without requiring re-estimation of model performance to change the extent of data augmentation.

Action 203, Action 204 and Action 205 may be considered to be comprised in a second phase of the method performed by the first node 111, which may be drawn to sample addition based on label-proximity.

### Action 206

In most practical use-cases, it may be advantageous to return to the input space from the projected space for the task of data augmentation. Obtaining augmented samples back in input space may be understood to refer to finding a representation in the original space of variables and/or features from the projected space for the samples. Although processing could in principle continue in the low dimensional space, this may be understood to not always be the desired use-case. This may be understood to be because the task of data augmentation, that is, the generation of new samples, may expect the output to be represented with the same number of variables as the input, so that the augmented dataset may be able to be validated as meaningful to work further with.

In this Action 206, the first node 111 generates a sixth set of augmented samples in the input space of the original dataset, by using the generated samples and applying a reverse projection approach to transform the generated samples into transformed samples of the input space of the original dataset, added to the original dataset.

In some embodiments, the generating in this Action 207 of the sixth set of augmented samples in the input space may comprise minimizing sum-of-squares values of variables in the input space.

The generating of the sixth set in this Action 206 may comprise solving an optimization problem with parameters to obtain the augmented sample in the input space and to control the quality of the reverse projection.

In particular embodiments, the generating in this Action 207 of the sixth set of augmented samples in the input space may introduce an error when applying the reverse projection approach to transform the generated samples into transformed samples of the input space of the original dataset. In some embodiments, the generating in this Action 207 of the sixth set of augmented samples may be further performed by: a) defining one or more first parameters to constrain the generated sixth set of augmented samples to one or more bounds of the original dataset, b) defining one or more tolerance parameters of the error, and c) minimizing the sum-of-squares values of the variables in the input space by solving an unconstrained problem based on the error and the defined one or more first parameters and one or more tolerance parameters. This is described in detail next.

For the reverse projection approach, the augmented sample in the low-dimensional space may be considered to be represented by x, using which the first node 111 may need to obtain the input space representation z. The forward projection obtained by the layers of the network may be considered as a transformation effected by sequential multiplication operations on the input sample, where the values of the matrices, e.g., ‘G’, as in the notation used in the following optimization problem described below, may be understood to represent the weights of the connections between neurons in the layers of the network.

The first node 111 may require reconstructing z from x under the consideration that G(z)=x and that first node 111 may need to obtain a minimum norm solution for z. This may be understood to also help to maintain the convexity of the problem to be solved. To ensure that the reverse projection obtained lies within the bounds of the original dataset, first node 111 may compute the lower and upper bounds, that is, the minimum and maximum values of the input samples across the dimensions, as vectors lb and ub respectively and constrain z to lie between them. Herein, lb and ub may be referred to as bound control parameters or first parameters. The first node 111 may define another first parameter, that is, another bound control parameter ∈, to control the region in which the obtained input sample may additionally lie, which may in turn allow us to introduce inequality constraints of the form G(z)−∈≤x≤G(z)+∈. Further, first node 111 may also define one or more tolerance parameters, e.g., tolerance parameters represented by variables q⁺ and q⁻, positively constrained, to provide additional tolerance for satisfying these inequality constraints, and first node 111 may further define configurable parameters C₁ and C₂ as weights on q⁺ and q⁻ respectively, which may be minimized in the objective function along with the norm of the solution vector z. This may be understood to effectively result in the quadratic optimization problem P given, according to known methods, as:

$$\\ {P}_{} : {min}_{z , {q}^{+} , {q}^{-}} {‖ z ‖}_{2}^{2} + {C}_{1} {\sum }_{i} {q}_{i}^{+} + {C}_{2} {\sum }_{j} {q}_{j}^{{}_{} -} , subject to constraints$$

$$\\ G ( z ) - ∈ - {q}_{i}^{+} \leq x \leq G ( z ) + ∈ + {q}_{j}^{{}_{} -} , lb \leq z \leq ub and {q}^{+} , {q}^{-} \geq 0$$

The optimization problem P may be conventionally solved by a quadratic programming problem solver routine sequentially for projecting each sample back to input space.

However, according to some embodiments herein, the problem may be converted to an unconstrained optimization problem as shown in equation (5) below by re-writing the constraints within the objective function by suitable substitutions of variables from the constraint equations. The unconstrained optimization problem may then be stochastically solved using Stochastic sub-Gradient Descent (SGD) by taking one sample at a time, computing the sub-gradients, as given by the set of equations (6) and updating the values of the solution vector as shown in equation (7). A suitable learning rate η may also be chosen to weigh the sub-gradient update. This may be repeated over a few iterations until convergence criteria may be met, which may conventionally require the difference between solutions obtained from two successive iterations to lie within a specified small threshold value. This may be understood to allow effective computation of the reverse projections, while also governing the input reconstruction by characteristics of the augmented samples.

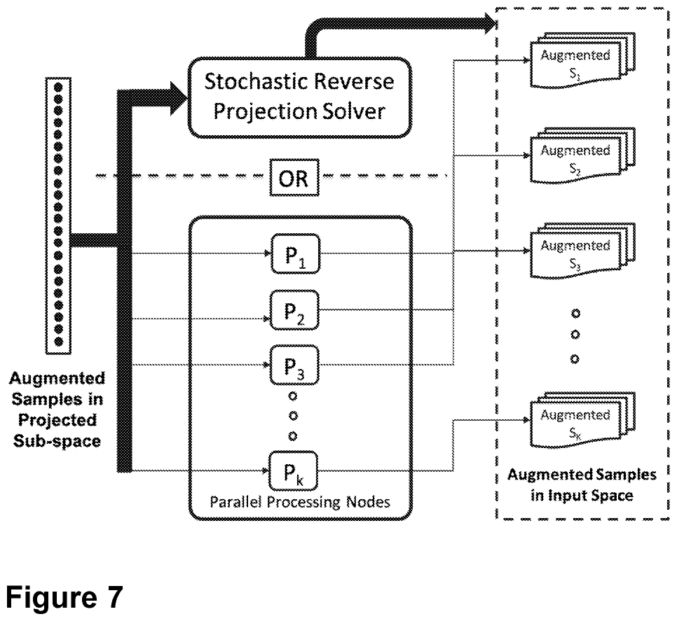

In an alternative implementation to parallelize the reverse projection, the least squares version of P may be solved to obtain a non-iterative solution over multiple parallel processing nodes as shown later in FIG. 7. Each of the nodes may directly compute the reverse projection for each sample, or the samples may also be divided equally among the number of available processing nodes. This may result in speedup of the implementation because of parallelization of the solving routine over multiple nodes.

By performing the reverse projection implementations in this Action 206, in combination with the techniques for combinatorial sampling of Action 201, and Action 202 and the label proximity-based sample addition of Action 206, the first node 111 may be enabled to effectively scale up the projection-based data augmentation pipeline.

$$\\ \begin{matrix}{min}_{z , {q}^{+} , {q}^{-}} \frac{1}{2} {‖ z ‖}_{2}^{2} + {C}_{1} {\sum }_{i} {( {q}_{i}^{+} )}^{2} + {C}_{2} {\sum }_{j} {( {q}_{j}^{-} )}^{2} & ( 1 )\end{matrix}$$

$$\\ \begin{matrix}Gz - {q}_{i}^{+} \leq x + ∈ & ( 2 )\end{matrix}$$

$$\\ \begin{matrix}Gz - {q}_{j}^{-} \geq x - ∈ & ( 3 )\end{matrix}$$

$$\\ \begin{matrix}lb \leq z \leq ub & ( 4 )\end{matrix}$$

The equivalent unconstrained problem is given as

$$\\ \begin{matrix}f = {min}_{z} \frac{1}{2} [ {( z - lb )}^{2} + {( ub - z )}^{2} ] + {\frac{{C}_{1}}{2} [ max ( 0 , Gz - x - ϵ ]}^{2} + {\frac{{C}_{2}}{2} [ max ( 0 , x - ϵ - Gz ]}^{2} & ( 5 )\end{matrix}$$

The partial derivative is given by

$$\\ \begin{matrix}{∇}_{z} f = \{ \begin{matrix}( z - lb ) - ( ub - z ) - {G}^{{}_{} T} ( x - ϵ - Gz ) , Gz < x - ϵ \\ ( z - lb ) - ( ub - z ) + 2 ( {G}^{{}_{} T} Gz - {G}^{{}_{} T} x ) , x - ϵ \leq Gz \leq x + ϵ \\ ( z - lb ) - ( ub - z ) + {G}^{{}_{} T} ( Gz - x - ϵ ) , Gz > x + ϵ\end{matrix} & ( 6 )\end{matrix}$$

For suitable learning rate q the above can be solved using the update rule at

$$\\ \begin{matrix}{z}_{( t + 1 )} = {z}_{t} - η {∇}_{z} f & ( 7 )\end{matrix}$$

The first node 111 may, in this Action 206, generate the sixth set of augmented samples by performing a scalable method for scalable synthetic data generation for high-dimensional datasets with a scalable approach for projecting the datasets back to the input space from the low-dimensional projection space(s). When augmentation is done at scale, there may be understood to be a need for a robust method that may perform the projection back to the input space fast enough, possibly by avoiding an iterative training procedure for projecting each sample, as well as a need to be able to work in parallel on multiple augmented samples to increase the scalability of the approach. The first node 111 may use a fast method that may avoid a sub-routine solver while also being inherently parallelizable. This reverse projection approach, though arising because of the need to perform the forward projection, may enable to determine the scale and quality of data augmentation, which is not found in conventional approaches. The determination of the scale may be due to the parallelization or stochastic solving embodiments. The determination of the quality may be due to the parameters for tolerance on errors and bounds.

As pointed out above, in some embodiments, the reverse projection approach may be one of: a) stochastic, and b) processing each of the generated samples in each cluster of the selected fifth set of clusters, in parallel, in a respective node of a seventh set of nodes.

In some embodiments, the stochastic approach may comprise running each generated sample through an optimization routine based on a sub-gradient. That is, the first approach may comprise using a stochastic version of the problem where the first node 111 may pick each sample, run it through a stochastic sub gradient-based optimization routine, discussed above, until convergence, and obtain the high dimensional sample. This may be understood to be faster to alternative implementations that may use a sub-routine solver to obtain the solution to the optimization problem through iterative techniques involving evaluation of all constraints for each sample or train a decoder network, such as in various network-based architectures including GANs or autoencoders.

The alternative realization of the reverse projection approach may be through parallelization of the solution process. In some embodiments, the approach using parallel processing in the seventh set of nodes may use a closed form least squares optimization procedure. In particular embodiments, the first node 111 may use the closed form least-squares solution of the optimization problem to directly compute the reverse projections of each augmented sample on an individual processing node, or core, in order to significantly scale up the reverse projection process in terms of computation time across multiple nodes, which may be indicated as P₁, P₂, . . . , Pₖ, e.g., in FIG. 7, which will be described later. The suitable implementation of the reverse projection approach may be chosen based on the application needs. The final output of this Action 206 may be understood to be the augmented samples within each of the K subsets of the original dataset generated during the first phase of our processing pipeline.

This Action 206 may be comprised in a third phase of the method performed by the drawn to a scalable parameterized reverse projection.

By generating the sixth set of augmented samples with the scalable and parameterized projection approach of this Action 206, the first node 111 may be enabled to obtain high dimensional representations of augmented samples using low dimensional projections obtained from network layers, e.g., implemented by Eqns. (5)-(7) solved by the stochastic projection solver, or solving the least squares variant on multiple parallel nodes, further parameterized by parameters on error variables and bounds to determine the quality of solution obtained.

By generating the sixth set of augmented samples in this Action 206, the first node 111, or the second node 112, may then be enabled to use these samples based on the objectives of the application in which the approach may be employed, which may include re-training the model with the augmented dataset, tune the augmentation parameters based on the quality of the augmented samples obtained, or provide the new samples for further processing as a service in the machine learning workflow pipeline of the application.

As an additional advantage, the first node 111 may be enabled to augment data samples in supervised settings, by exploiting label information in Action 205 and, through independent forward and reverse projections, alleviate the generator-discriminator dependency in GAN-like architectures, while also allowing for quality control of the generated samples.

The scalable parameterized reverse projection approach that may be realized using sequential or parallel solvers, in conjunction with the subset generation and label-based sample addition schemes may be understood to achieve the effect of scalable and representative data augmentation.

### Action 207

In some embodiments, the first node 111 may, in this Action 207, provide a further indication indicating the generated sixth set of augmented samples to the second node 112 operating in the communications system 100.

The providing, e.g., sending of the further indication may be performed, e.g., via the first link 141.

By providing the further indication in this Action 207, the first node 111 may enable the second node 112 to train a model, e.g., a machine-learning model to analyze one or more events in the communications network 100 using the generated sixth set of augmented samples, and ultimately take an action accordingly, for example, manage their occurrence.

### Action 208

In some embodiments, the first node 111 may itself, in this Action 208, determine a first machine learning model of an event in the communications system 100 using as input the generated sixth set of augmented samples.

The method performed by the first node 111 may be applicable to various projects/use cases including Key Performance Indicators (KPI) traffic balancing, network transfer learning, among others.

By determining the first machine learning model of the event in the communications system 100 using as input the generated sixth set of augmented samples in this Action 208, the first node 111 may be enabled to build generalized models and address class imbalance issues. By the approach being generic in nature, it may be understood to not restrict the dimensions on the input or projection spaces. The first machine learning model may therefore be accurate and thereby enable to ultimately take a better action in relation to the event, for example, perform an improved management of its occurrence. As the first machine learning model may need to be scalable and feature space may be high dimensional, the reverse projection approach performed by the first node 111 may be understood to be more suitable.

### Action 209

In some embodiments, the first node 111 may, in this Action 209, initiate performance of an action to manage a predicted occurrence of the event according to the determined first machine learning model.

By initiating performance of the action to manage the predicted occurrence of the event according to the determined first machine learning model in this Action 209, the first node 111 may be enabled to perform an improved management of its occurrence.

Embodiments of a computer-implemented method, performed by the second node 112, will now be described with reference to the flowchart depicted in FIG. 3. The method may be understood to be for handling data augmentation. The second node 112 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 112 is depicted in FIG. 3. In FIG. 3, optional actions in some embodiments may be represented with dashed lines. The detailed description of some of the following corresponds to the same references provided above, in relation to the actions described for the first node 111 and will thus not be repeated here to simplify the description. For example, the feature/variable space of the samples may be high dimensional, or low dimensional after transformation may be applied as a result of passing them through a machine learning model.

### Action 301

In this Action 301, the second node 112 receives a further indication from a first node 111 operating in the communications system 100. The further indication indicates the sixth set of augmented samples generated according to any of Actions 201-207 described above.

The receiving in this Action 301 may be performed e.g., via the first link 161.

### Action 302

In this Action 302, the second node 112 may determine the first machine learning model of the event in the communications system 100 using as input the generated sixth set of augmented samples indicated in the received further indication.

### Action 303

In this Action 303, the second node 112 may, in this Action 303, initiate performance of the action to manage the predicted occurrence of the event according to the determined first machine learning model.

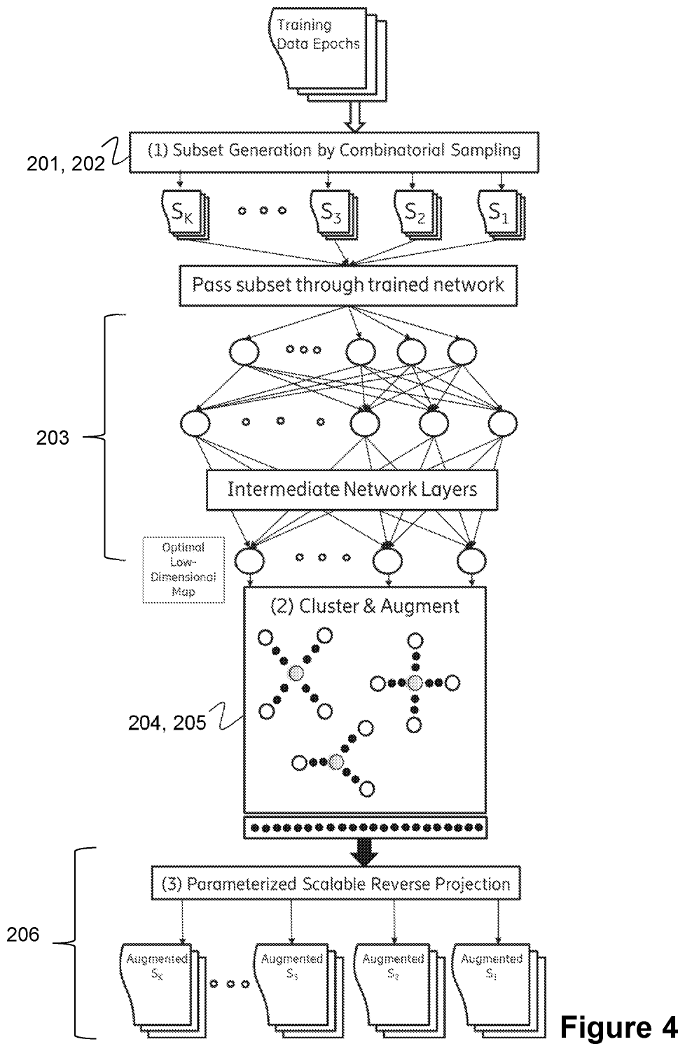

FIG. 4 is a schematic diagram depicting a non-limiting example of a method performed by the first node 111 according to embodiments herein. The method for scalable synthetic data generation using projections performed by the first node 111 may be realized by a three-phase approach. FIG. 4 shows the overall flow of the proposed approach in the sequence in which the constituent phases may be executed (L to R). The phases are discussed in the order of implementation. Phase 1 may be understood to comprise the subset generation by combinatorial sampling of batches. According to Action 201, batches from the training data epochs may be used to generate subsets in Action 202, and then obtain forward projections by passing through the network architecture and cluster according to Action 204. Phase 2 may be understood to comprises the cluster selection and label-proximity based sample addition to augment the data according to Action 205. Phase 3 may be understood to comprise scalable parameterized reverse projection according to Action 206 to finally project back the generated samples into input space to obtain the augmented dataset.

The training data epochs, of a labelled dataset, may be used as input to the subset generator which may use combinatorial sampling to generate subsets of the data samples in the individual batches. These may then be passed through a trained network which may be a shallow or deep network. The intermediate representation obtained at a suitable layer of the network may be chosen as the optimal low dimensional map for the set of samples, and an augmentation approach may be employed on the samples in this projected space by clustering. This may involve augmentation using parameters that may exploit label information to determine the extent of augmentation. The augmented samples, shown in black circles in FIG. 4, may be aggregated and passed through the parameterized scalable reverse projection approach to obtain the augmented samples for the corresponding subset in input space. These augmented samples may be used as required by the application where the approach may be employed. The scalable parameterized reverse projection scheme described, may be used in conjunction with the other two aspects, subset generation and label proximity-based sample addition, to realize the overall intended effect.

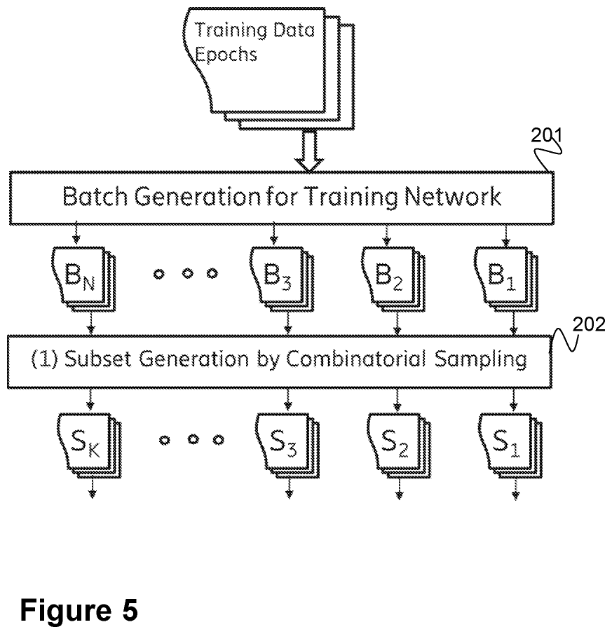

FIG. 5 is schematic diagram depicting the subset generation from the input dataset represented as the training data epochs which may be used for training the network. Within each epoch, the dataset, according to Action 201, may be divided into batches denoted by B₁, B₂, and so on until BN. This may be conventionally performed using a suitable stratified approach for mini batch generation so that samples of the classes of interest may be well represented in each batch. Within each batch, multiple subsets of the training data may be generated according to Action 202. These subsets, denoted as S₁, S₂ and so on until S_{K}, may be generated by selecting k samples from each batch of n samples for N batches by choosing different values of k, resulting in generation of K subsets. FIG. 5 illustrates the subset generation from the input dataset. The epochs shown on the left are passed in batches, and from each batch, subsets may be generated by combinatorial sampling.

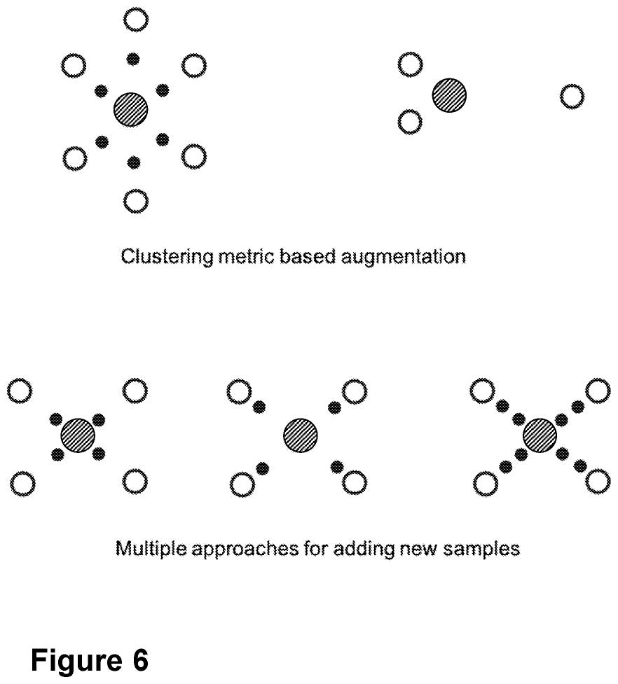

FIG. 6 is a schematic representation of approaches adopted for augmentation according to Action 205. The top panel shows that samples may be added, as depicted by solid black dots, only when clusters may be good. The left cluster is well represented compared to the ones on the right. The bottom panel shows different ways to add the new samples: closer to the respective cluster center, as depicted on the left cluster, or closer to the sample, as depicted on the cluster in the middle, or both, as depicted on the cluster on the right. Indicative samples and their corresponding cluster centers are represented as white and striped circles respectively in FIG. 6.

FIG. 7 is a schematic representation showing the components for reverse projection of the augmented samples in the low dimensional space back to the input space of the original dataset, in accordance with Action 206. Both the possible realizations of the approach, including stochastic or parallel solvers, are shown. The reverse projection approach may be implemented on the augmented samples represented by black dots in two ways as shown in FIG. 7. The first approach may be by using the stochastic version of the problem using a stochastic reverse projection solver. The alternative realization of the reverse projection approach may be through parallelization of the solution process, across multiple nodes indicated as P₁, P₂, . . . , Pₖ in the figure. The result may be understood to be the augmented samples in the input space, denoted as Augmented S₁, Augmented S₂ and so on until Augmented S_{K}.

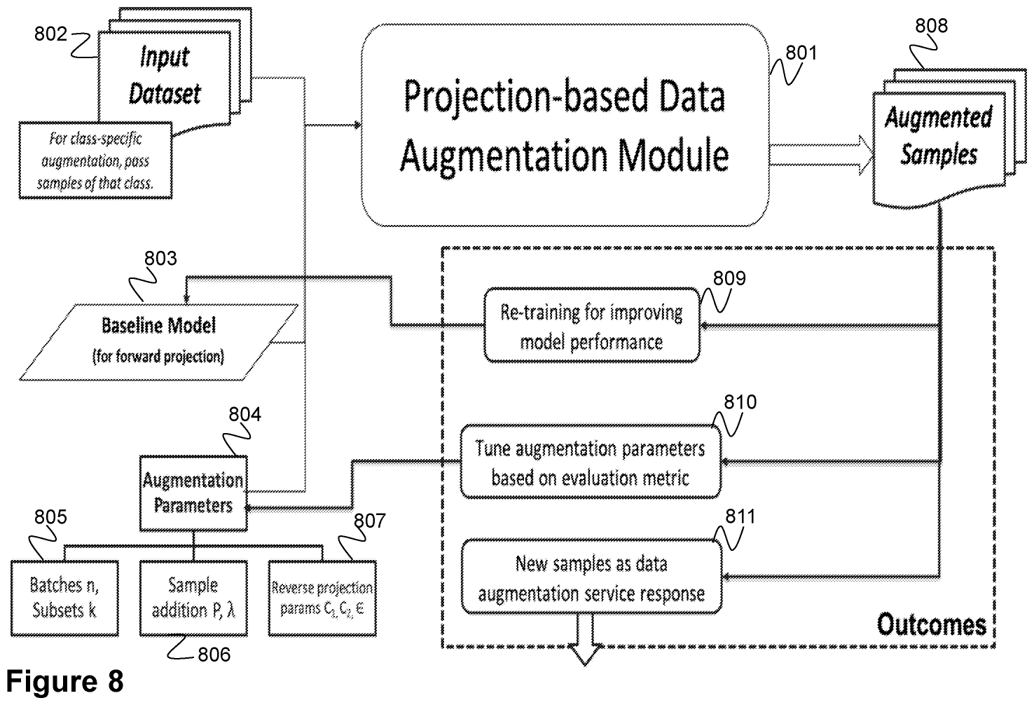

FIG. 8 is a schematic representation of the overall workflow of the method performed by the first node 111, which may be employed for the augmentation of an input dataset in the supervised setting. The method performed by the first node 111 is schematically depicted by the box labeled projection-based data augmentation module 801. The first node 111 may take as input the samples of the training dataset 802 which need to be augmented along with the baseline network model 803, a trained model to compute the forward projections, which may be a shallow or deep neural network, or any other machine learning model. In addition, the sets of parameters for augmentation 804, including the number of batches (n) and subsets (k) 805 to generate in step (1) of the approach, the number of samples to add (P) and the ratio in which to add these samples in the low dimensional space (λ) 806 in step (2), and the parameters for computing the reverse projection back to input space (C1, C2 and ∈) 807 in step (3) are provided as input. The projection-based data augmentation module generates the augmented samples 808 as output. The final output of this Action 206 may be understood to be the augmented samples 808 within each of the K subsets of the original dataset generated during the first phase of the processing pipeline. Using these samples, multiple applications may be realized, such as re-training the model to improve performance at 809, changing the parameters used to get another set of new data points at 810, or provide the new points as a service for consumption by any other application at 810.

As a summarized overview of the foregoing, embodiments herein may be understood to relate to three aspects. A first aspect may be understood to be generating subsets from batches of training epochs using a combinatorial sampling scheme for enabling generation of many augmented data samples.

A second aspect may be understood to be a label-proximity based sample additional scheme for the clustered low dimensional representations of input samples, so that a larger number of samples representative of the classes of interest may be added after evaluating the label-based metric, as for example, may be required by a user.

A second aspect may be understood to be a scalable and parameterized projection approach for obtaining high dimensional representations of augmented samples using low dimensional projections obtained from network layers, implemented by Eqns. (5)-(7) solved by the stochastic projection solver, or solving the least squares variant on multiple parallel nodes, further parameterized by bound control and tolerance parameters to determine quality of the samples obtained as a result.

These three aspects may be understood to enable the first node 111 to generate the augmented dataset samples by inherently using the training network architecture towards the overall effect of realizing an approach for large scale data augmentation.

Certain embodiments disclosed herein may provide one or more of the following technical advantage(s), which may be summarized as follows. Embodiments herein may be understood to offer advantages in each stage of the processing pipeline, including scale of data augmentation, addition of new samples based on evaluation of metrics in the projected space of representation of samples, and a scalable, parameterized reverse projection approach for reconstruction of the augmented samples back to input space.

A first advantage of embodiments herein may be understood to be provided by the scalable reverse projection approach, which may include scalability for faster projection of augmented samples back to input space and scope for parallelization for projecting multiple samples simultaneously. This may be facilitated by a variant of the least squares' solution of the problem from [10]. The optimization problem may have parameters that may control the quality of the solution obtained, which may be understood to make it amenable to obtain input space samples based on specific user requirements that may be realized by changing these parameter values. This is unlike conventional approaches where these aspects cannot be controlled or are not within the scope of the processing pipeline. Embodiments herein may aim to develop a pipeline for augmentation of datasets in a supervised setting by exploiting the optimal map obtained during network training, and further provide a scalable approach, that may also be parallelized, for fast reconstruction to input space.

A second advantage of embodiments herein may be understood to be to allow to scale the augmentation process by using parameters for determining the extent of augmentation to be performed. Unlike conventional approaches where augmentation is usually done to compensate for class imbalance only, embodiments herein may be understood to enable augmentation for datasets without class imbalance as well, since samples of all classes may be augmented to increase the size of the training set. While class imbalance may be performed according to embodiments herein too, e.g., in Actions 203-205, embodiments herein may be advantageously applied if all classes had few samples, and augmentation of the original dataset was desired. This can be suitably re-worded. Embodiments herein may exploit label information to compute a metric that may determine the extent of augmentation in the projected space, which may potentially lead to generation of several samples that may be representative of the discriminative information available in the original dataset.

Embodiments herein may be understood to enable incorporation into conventional network training pipelines for feedforward shallow networks or for deep neural network applications. Data subsets may be generated from batches of input training epochs by a combinatorial approach, that may be configured in the operational pipeline of the learning model. The projection approach may leverage the mapping obtained by the network layers, and the first node 111 may work with diverse representations in the projected space from the subsets generated by combinatorial sampling of the batches. The metrics for augmentation may be understood to not per se require re-evaluation through the network, as may have to be done in conventional approaches, which may save on compute time as well.

Furthermore, embodiments herein may be understood to not use a decoder as in an autoencoder. Embodiments herein may be used non-iteratively, or executed in parallel, on multiple samples added in the projected space. Thus, the disadvantage induced by the need to train the decoder network if an autoencoder was to be used for the data augmentation task may be understood to be alleviated.

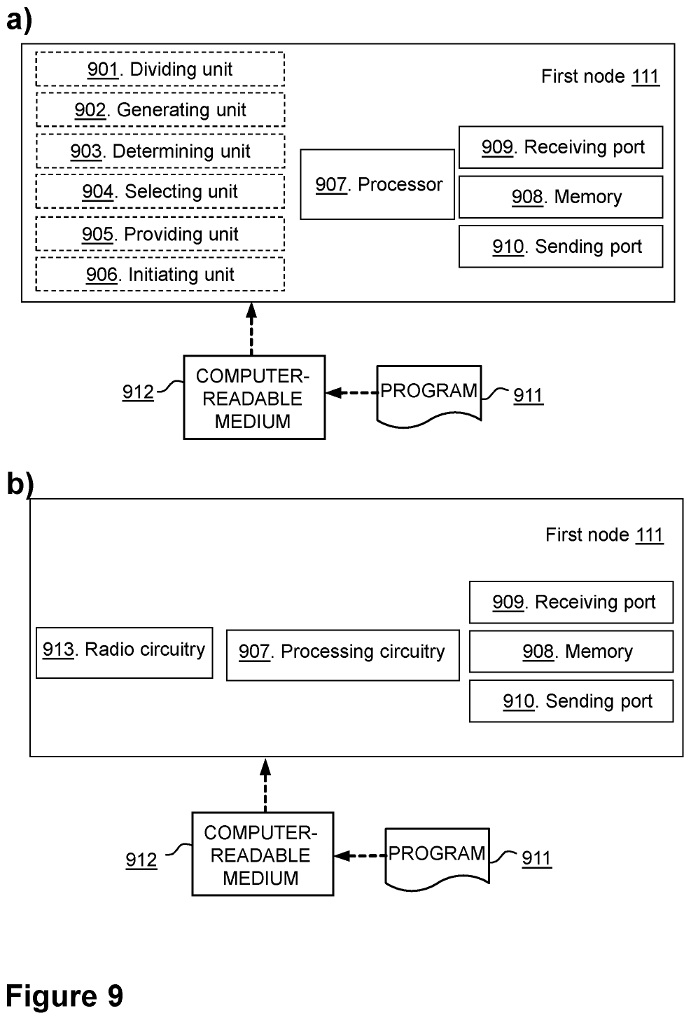

FIG. 9 depicts two different examples in panels a) and b), respectively, of the arrangement that the first node 111 may comprise to perform the method actions described above in relation to FIG. 2, and/or FIGS. 4-8. In some embodiments, the first node 111 may comprise the following arrangement depicted in FIG. 9a. The first node 111 may be understood to be for handling data augmentation. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the first node 111 and will thus not be repeated here. For example, the batches may be configured to be distinct, non-overlapping partitions of the data.

The first node 111 is configured to, e.g. by means of a dividing unit 901 within the first node 111 configured to, divide each epoch, of the first set of training data epochs in the original dataset having the input space, into the second set, N, of batches.

The first node 111 is also configured to, e.g. by means of a generating unit 902 within the first node 111 configured to, generate the third set, K, of subsets of samples by selecting, within each batch from every second set, N, of batches, the respective plurality of subsets of the one or more samples. Each subset is configured to be different from another subset.

The first node 111 is further configured to, e.g. by means of a determining unit 903 within the first node 111 configured to, determine, using machine learning, the fourth set of clusters of data using the determined third set, K, of subsets of samples as input.

In some embodiments, the first node 111 is further configured to, e.g. by means of a selecting unit 904 within the first node 111 configured to, select the fifth set of clusters from the fourth set of clusters based on the criterion of relevance.

The first node 111 is also configured to, e.g. by means of the generating unit 902 within the first node 111 configured to, generate the samples in each cluster of the selected fifth set of clusters, and refrain from generating samples in the clusters of the fourth set of clusters being excluded from the fifth set of clusters.

The first node 111 is also configured to, e.g. by means of the generating unit 902 within the first node 111 configured to, generate the sixth set of augmented samples in the input space of the original dataset, by using the generated samples and applying the reverse projection approach to transform the generated samples into the transformed samples of the input space of the original dataset, added to the original dataset.

In some embodiments, the criterion of relevance may be configured to be the respective indication exceeding the threshold. In some of such embodiments, the respective indication may be configured to be of the ratio of the respective number of samples of the respective class in each respective cluster of the fourth set of clusters of data, to the respective total number of samples in the respective cluster.

In some embodiments, the reverse projection approach may be configured to be one of: a) stochastic, and b) processing each of the samples configured to be generated in each cluster of the selected fifth set of clusters, in parallel, in the respective node of the seventh set of nodes.

In some embodiments, the stochastic approach may be configured to comprise running each generated sample through an optimization routine based on the sub-gradient.

In some embodiments, the approach using parallel processing in the seventh set of nodes may be configured to use the closed form least squares optimization procedure.

In some embodiments, the generating of the third set may be configured to be performed by using combinatorial sampling.

In some embodiments, each cluster of the fourth set of clusters may be configured to have the respective center. In some of such embodiments, the generating of samples may be configured to be performed in at least one of: a) within the first distance from the respective center of the respective cluster, b) within the second distance from the respective sample in the projected space belonging to the respective cluster, and c) within the certain distance between the respective center of the respective cluster and the respective sample.

In some embodiments, the generating of the sixth set of augmented samples in the input space may be configured to comprise minimizing sum-of-squares values of variables in the input space.

In some embodiments, the generating of the sixth set of augmented samples in the input space may be configured to introduce the error when applying the reverse projection approach to transform the generated samples into transformed samples of the input space of the original dataset. In some of such embodiments, the generating of the sixth set of augmented samples may be further configured to be performed by: a) defining the one or more first parameters to constrain the generated sixth set of augmented samples to one or more bounds of the original dataset, b) defining the one or more tolerance parameters of the error, and c) minimizing the sum-of-squares values of the variables in the input space by solving the unconstrained problem based on the error and the defined one or more first parameters and one or more tolerance parameters.

In some embodiments, the first node 111 may be further configured to, e.g. by means of a providing unit 905 within the first node 111 configured to, provide the further indication configured to indicate the generated sixth set of augmented samples to the second node 112 configured to operate in the communications system 100.

The first node 111 may be further configured to, e.g. by means of the determining unit 903 within the first node 111 configured to, determine the first machine learning model of the event in the communications system 100 using as input the generated sixth set of augmented samples.

In some embodiments, the first node 111 may be further configured to, e.g. by means of an initiating unit 906 within the first node 111 configured to, initiate performance of the action to manage the predicted occurrence of the event according to the determined first machine learning model.

The embodiments herein may be implemented through one or more processors, such as a processor 907 in the first node 111 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 908 comprising one or more memory units. The memory 908 is arranged to be used to store obtained information, store data, configurations, schedulings, and applications etc. to perform the methods herein when being executed in the first node 111.

In some embodiments, the first node 111 may receive information from, e.g., the second node 112, and/or another node through a receiving port 909. In some examples, the receiving port 909 may be, for example, connected to one or more antennas in the first node 111. In other embodiments, the first node 111 may receive information from another structure in the communications system 100 through the receiving port 909. Since the receiving port 909 may be in communication with the processor 907, the receiving port 909 may then send the received information to the processor 907. The receiving port 909 may also be configured to receive other information.

The processor 907 in the first node 111 may be further configured to transmit or send information to e.g., the second node 112, another node, and/or another structure in the communications system 100, through a sending port 910, which may be in communication with the processor 907, and the memory 908.

Those skilled in the art will also appreciate that any of the units 901-906 described above may refer to a combination of analog and digital circuits, and/or one or more processors configured with software and/or firmware, e.g., stored in memory, that, when executed by the one or more processors such as the processor 907, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-906 described above may be the processor 907 of the first node 111, or an application running on such processor.

Thus, the methods according to the embodiments described herein for the first node 111 may be respectively implemented by means of a computer program 911 product, comprising instructions, i.e., software code portions, which, when executed on at least one processor 907, cause the at least one processor 907 to carry out the actions described herein, as performed by the first node 111. The computer program 911 product may be stored on a computer-readable storage medium 912. The computer-readable storage medium 912, having stored thereon the computer program 911, may comprise instructions which, when executed on at least one processor 907, cause the at least one processor 907 to carry out the actions described herein, as performed by the first node 111. In some embodiments, the computer-readable storage medium 912 may be a non-transitory computer-readable storage medium, such as a CD ROM disc, a memory stick, or stored in the cloud space. In other embodiments, the computer program 911 product may be stored on a carrier containing the computer program, wherein the carrier is one of an electronic signal, optical signal, radio signal, or the computer-readable storage medium 912, as described above.

The first node 111 may comprise an interface unit to facilitate communications between the first node 111 and other nodes or devices, e.g., the second node 112, another node, and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 907, e.g., one or more processors such as the processor 907, in the first node 111 and the memory 908. The first node 111 may also comprise a radio circuitry 913, which may comprise e.g., the receiving port 909 and the sending port 910. The processing circuitry 907 may be configured to, or operable to, perform the method actions according to FIG. 2, and/or FIGS. 4-8, in a similar manner as that described in relation to FIG. 9a. The radio circuitry 913 may be configured to set up and maintain at least a wireless connection with the second node 112, another node, and/or another structure in the communications system 100.

Hence, embodiments herein also relate to the first node 111 operative for handling data augmentation, the first node 111 being operative to operate in the communications system 100. The first node 111 may comprise the processing circuitry 907 and the memory 908, said memory 908 containing instructions executable by said processing circuitry 907, whereby the first node 111 is further operative to perform the actions described herein in relation to the first node 111, e.g., in FIG. 2, and/or FIGS. 4-8.

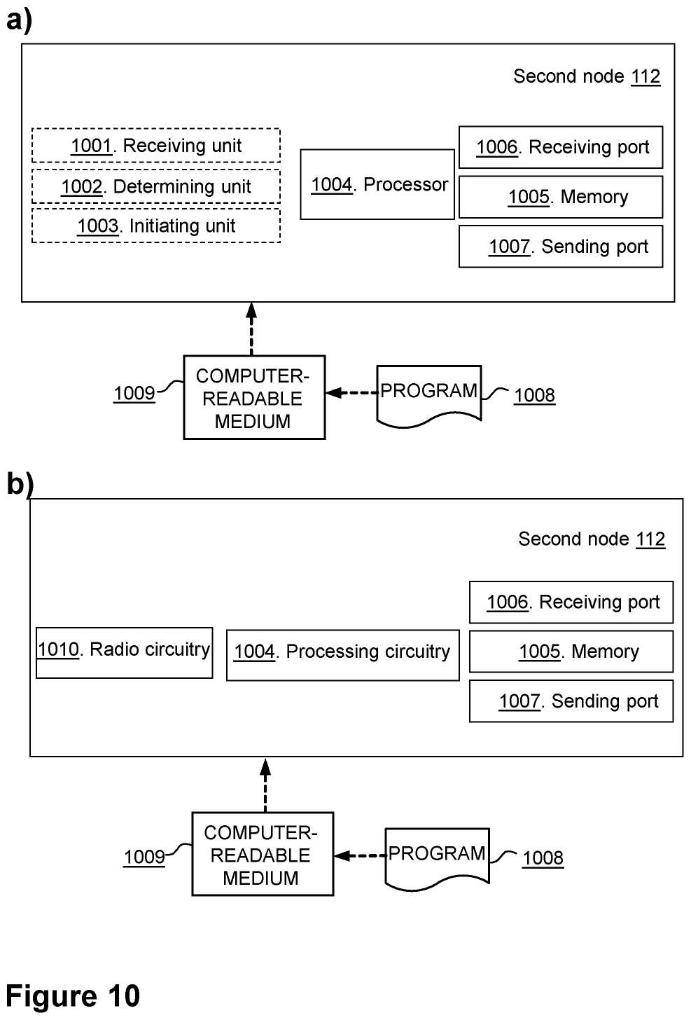

FIG. 10 depicts two different examples in panels a) and b), respectively, of the arrangement that the second node 112 may comprise to perform the method actions described above in relation to FIG. 3, and/or FIGS. 4-8. In some embodiments, the second node 112 may comprise the following arrangement depicted in FIG. 10a. The second node 112 may be understood to be for data augmentation. The second node 112 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 10, optional boxes are indicated by dashed lines. The detailed description of some of the following corresponds to the same references provided above, in relation to the actions described for the first node 111 and will thus not be repeated here. For example, the first machine learning model may be determined with a neural network.

The second node 112 is configured to, e.g. by means of a receiving unit 1001 within the second node 112 configured to, receive the further indication from the first node 111 configured to operate in the communications system 100. The further indication may be configured to indicate the sixth set of augmented samples configured to be generated according to any of claims Actions 201-Action 206.

The second node 112 may be also configured to, e.g. by means of a determining unit 1002 within the second node 112 configured to, determine the first machine learning model of the event in the communications system 100 using as input the generated sixth set of augmented samples indicated in the received further indication.

The second node 112 may also be configured to, e.g. by means of an initiating unit 1003 within the second node 112 configured to, initiate performance of the action to manage the predicted occurrence of the event according to the determined first machine learning model.

The embodiments herein may be implemented through one or more processors, such as a processor 1004 in the second node 112 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1005 comprising one or more memory units. The memory 1005 is arranged to be used to store obtained information, store data, configurations, schedulings, and applications etc. to perform the methods herein when being executed in the second node 112.

In some embodiments, the second node 112 may receive information from, e.g., the first node 111, and/or another node, through a receiving port 1006. In some examples, the receiving port 1006 may be, for example, connected to one or more antennas in the second node 112. In other embodiments, the second node 112 may receive information from another structure in the communications system 100 through the receiving port 1006. Since the receiving port 1006 may be in communication with the processor 1004, the receiving port 1006 may then send the received information to the processor 1004. The receiving port 1006 may also be configured to receive other information.

The processor 1004 in the second node 112 may be further configured to transmit or send information to e.g., the first node 111, another node, and/or another structure in the communications system 100, through a sending port 1007, which may be in communication with the processor 1004, and the memory 1005.

Those skilled in the art will also appreciate that the units 1001-1004 described above may refer to a combination of analog and digital circuits, and/or one or more processors configured with software and/or firmware, e.g., stored in memory, that, when executed by the one or more processors such as the processor 1004, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1001-1004 described above may be the processor 1004 of the second node 112, or an application running on such processor.

Thus, the methods according to the embodiments described herein for the second node 112 may be respectively implemented by means of a computer program 1008 product, comprising instructions, i.e., software code portions, which, when executed on at least one processor 1004, cause the at least one processor 1004 to carry out the actions described herein, as performed by the second node 112. The computer program 1008 product may be stored on a computer-readable storage medium 1009. The computer-readable storage medium 1009, having stored thereon the computer program 1008, may comprise instructions which, when executed on at least one processor 1004, cause the at least one processor 1004 to carry out the actions described herein, as performed by the second node 112. In some embodiments, the computer-readable storage medium 1009 may be a non-transitory computer-readable storage medium, such as a CD ROM disc, a memory stick, or stored in the cloud space. In other embodiments, the computer program 1008 product may be stored on a carrier containing the computer program, wherein the carrier is one of an electronic signal, optical signal, radio signal, or the computer-readable storage medium 1009, as described above.

The second node 112 may comprise an interface unit to facilitate communications between the second node 112 and other nodes or devices, e.g., the first node 111, the another node, and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 10b. The second node 112 may comprise a processing circuitry 1004, e.g., one or more processors such as the processor 1004, in the second node 112 and the memory 1005. The second node 112 may also comprise a radio circuitry 1010, which may comprise e.g., the receiving port 1006 and the sending port 1007. The processing circuitry 1004 may be configured to, or operable to, perform the method actions according to FIG. 3, and/or FIGS. 4-8, in a similar manner as that described in relation to FIG. 10a. The radio circuitry 1010 may be configured to set up and maintain at least a wireless connection with the first node 111, another node, and/or another structure in the communications system 100.

Hence, embodiments herein also relate to the second node 112 operative for handling data augmentation, the second node 112 being operative to operate in the communications system 100. The second node 112 may comprise the processing circuitry 1004 and the memory 1005, said memory 1005 containing instructions executable by said processing circuitry 1004, whereby the second node 112 is further operative to perform the actions described herein in relation to the second node 112, e.g., in FIG. 3, and/or FIGS. 4-8.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. Data Augmentation in Transaction Classification using a Neural Network (US20200210808A1)
2. Learning Data Augmentation Policies (U.S. Ser. No. 10/817,805B2, US20210019658A1)
3. Training Neural Networks using Data Augmentation Policies (US20210097348A1)
4. Neural Network Training Method, Data Processing Method and Related Apparatuses (WO2021057186A1)
5. Neural Networks using intra-loop Data Augmentation during Network Training (US20200110994A1)
6. Methods and systems for automatic generation of massive training data sets from 3D models for training deep learning networks (U.S. Ser. No. 10/489,683B1)
7. Antoniou, Antreas, Amos Storkey, and Harrison Edwards. “Data augmentation generative adversarial networks.” arXiv preprint arXiv:1711.04340 (2017).
8. Odena, Augustus, Christopher Olah, and Jonathon Shlens. “Conditional image synthesis with auxiliary classifier GANs.” International conference on machine learning. PMLR, 2017.
9. He, Zhuoxun, et al. “Data augmentation revisited: Rethinking the distribution gap between clean and augmented data.” arXiv preprint arXiv:1909.09148 (2019).
10. Soman, Sumit, Jayadeva and Soumya Saxena. “EigenSample: A non-iterative technique for adding samples to small datasets.” Applied Soft Computing 70 (2018): 1064-1077.

1. A computer-implemented method, performed by a first node, the method being for handling data augmentation, the first node operating in a communications system, the method comprising:
dividing each epoch, of a first set of training data epochs in an original dataset having an input space, into a second set, N, of batches,
generating a third set, K, of subsets of samples by selecting, within each batch from every second set, N, of batches, a respective plurality of subsets of one or more samples, each subset being configured to be different from another subset,
determining, using machine learning, a fourth set of clusters of data using the determined third set, K, of subsets of samples as input,
selecting a fifth set of clusters from the fourth set of clusters based on a criterion of relevance,
generating samples in each cluster of the selected fifth set of clusters, and refraining from generating samples in clusters of the fourth set of clusters being excluded from the fifth set of clusters, and
generating a sixth set of augmented samples in the input space of the original dataset, by using the generated samples and applying a reverse projection approach to transform the generated samples into transformed samples of the input space of the original dataset, added to the original dataset.

2. The method according to claim 1, wherein the criterion of relevance is a respective indication exceeding a threshold, the respective indication being of a ratio of a respective number of samples of a respective class in each respective cluster of the fourth set of clusters of data, to a respective total number of samples in the respective cluster.

3. The method according to claim 1, wherein the reverse projection approach is one of: a) stochastic, and b) processing each of the generated samples in each cluster of the selected fifth set of clusters, in parallel, in a respective node of a seventh set of nodes.

4. The method according to claim 3, wherein one of:
a. the stochastic approach comprises running each generated sample through an optimization routine based on a sub-gradient, and
b. the approach using parallel processing in the seventh set of nodes uses a closed form least squares optimization procedure.

5. The method according to claim 1, wherein the generating is performed by using combinatorial sampling.

6. The method according to claim 1, wherein each cluster of the fourth set of clusters has a respective center, and wherein, the generating samples is performed in at least one of:
a. within a first distance from the respective center of a respective cluster,
b. within a second distance from a respective sample in a projected space belonging to the respective cluster, and
c. within a certain distance between the respective center of the respective cluster and the respective sample.

7. The method according to claim 1, wherein the generating of the sixth set of augmented samples in the input space comprises minimizing sum-of-squares values of variables in the input space.

8. The method according to claim 7, wherein the generating of the sixth set of augmented samples in the input space introduces an error when applying the reverse projection approach to transform the generated samples into transformed samples of the input space of the original dataset, and wherein the generating of the sixth set of augmented samples comprises:
a. defining one or more first parameters to constrain the generated sixth set of augmented samples to one or more bounds of the original dataset,
b. defining one or more tolerance parameters of the error, and
c. minimizing the sum-of-squares values of the variables in the input space by solving an unconstrained problem based on the error and the defined one or more first parameters and one or more tolerance parameters.

9. The method according to claim 1, further comprising:
providing a further indication indicating the generated sixth set of augmented samples to a second node operating in the communications system.

10. The method according to claim 1, further comprising:
determining a first machine learning model of an event in the communications system using as input the generated sixth set of augmented samples.

11. The method according to claim 11, further comprising:
initiating performance of an action to manage a predicted occurrence of the event according to the determined first machine learning model.

12. A computer-implemented method, performed by a second node, the method being for handling data augmentation, the second node operating in a communications system, the method comprising:
receiving a further indication from a first node operating in the communications system, the further indication indicating a sixth set of augmented samples generated by:
dividing each epoch, of a first set of training data epochs in an original dataset having an input space, into a second set, N, of batches,
generating a third set, K, of subsets of samples by selecting, within each batch from every second set, N, of batches, a respective plurality of subsets of one or more samples, each subset being configured to be different from another subset,
determining, using machine learning, a fourth set of clusters of data using the determined third set, K, of subsets of samples as input,
selecting a fifth set of clusters from the fourth set of clusters based on a criterion of relevance,
generating samples in each cluster of the selected fifth set of clusters, and refraining from generating samples in clusters of the fourth set of clusters being excluded from the fifth set of clusters, and
generating a sixth set of augmented samples in the input space of the original dataset, by using the generated samples and applying a reverse projection approach to transform the generated samples into transformed samples of the input space of the original dataset, added to the original dataset.

13. The method according to claim 12, further comprising:
determining a first machine learning model of an event in the communications system using as input the generated sixth set of augmented samples indicated in the received further indication.

14. The method according to claim 13, further comprising:
initiating performance of an action to manage a predicted occurrence of the event according to the determined first machine learning model.

15. A first node, for handling data augmentation, the first node being configured to operate in a communications system, the first node being further configured to:
divide each epoch, of a first set of training data epochs in an original dataset having an input space, into a second set, N, of batches,
generate a third set, K, of subsets of samples by selecting, within each batch from every second set, N, of batches, a respective plurality of subsets of one or more samples, each subset being different from another subset,
determine, using machine learning, a fourth set of clusters of data using the determined third set, K, of subsets of samples as input,
select a fifth set of clusters from the fourth set of clusters based on a criterion of relevance,
generate samples in each cluster of the selected fifth set of clusters, and refrain from generating samples in clusters of the fourth set of clusters being excluded from the fifth set of clusters, and
generate a sixth set of augmented samples in the input space of the original dataset, by using the generated samples and applying a reverse projection approach to transform the generated samples into transformed samples of the input space of the original dataset, added to the original dataset.

16. The first node according to claim 15, wherein the criterion of relevance is configured to be a respective indication exceeding a threshold, the respective indication being configured to be of a ratio of a respective number of samples of a respective class in each respective cluster of the fourth set of clusters of data, to a respective total number of samples in the respective cluster.

17.-25. (canceled)

26. A second node, for handling data augmentation, the second node being configured to operate in a communications system, the second node being further configured to:
receive a further indication from a first node configured to operate in the communications system, the further indication being configured to indicate a sixth set of augmented samples configured to be generated by:
dividing each epoch, of a first set of training data epochs in an original dataset having an input space, into a second set, N, of batches,
generating a third set, K, of subsets of samples by selecting, within each batch from every second set, N, of batches, a respective plurality of subsets of one or more samples, each subset being configured to be different from another subset,
determining, using machine learning, a fourth set of clusters of data using the determined third set, K, of subsets of samples as input,
selecting a fifth set of clusters from the fourth set of clusters based on a criterion of relevance,
generating samples in each cluster of the selected fifth set of clusters, and refraining from generating samples in clusters of the fourth set of clusters being excluded from the fifth set of clusters, and
generating a sixth set of augmented samples in the input space of the original dataset, by using the generated samples and applying a reverse projection approach to transform the generated samples into transformed samples of the input space of the original dataset, added to the original dataset.

27. The second node according to claim 26, being further configured to:
determine a first machine learning model of an event in the communications system using as input the generated sixth set of augmented samples indicated in the received further indication.

28. (canceled)

29. A computer program product comprising a non-transitory computer readable medium storing a computer program comprising instructions which, when executed on at least one processor, cause the at least one processor to carry out the method according to claim 1.

30. (canceled)

31. A computer program product comprising a non-transitory computer readable medium storing a computer program comprising instructions which, when executed on at least one processor, cause the at least one processor to carry out the method according to claim 12.

32. (canceled)
